(19) United States
(12) Patent Application Publication
(10) Pub. No.: US 2024/0284827 A1
(43) Pub. Date: Aug. 29, 2024

(54) SYSTEMS FOR GROWING AND PROCESSING PLANTS AND PLANT MATERIALS

(71) Applicant: EHEMPHOUSE CORP., Binghamton, NY (US)

(72) Inventors: Andrew T. Neal, Binghamton, NY (US); Nicholas Hewitt, Binghamton, NY (US)

(21) Appl. No.: 18/572,306

(22) PCT Filed: Jun. 22, 2022
(86) PCT No.: PCT/US2022/034468

§ 371 Date: Dec. 20, 2023

Related U.S. Application Data
(60) Provisional application No. 63/213,475, filed on Jun. 22, 2021.

(51) Int. Cl. A01D 43/08; C11B 1/04; C11B 1/06; C11B 1/10

(52) U.S. Cl. CPC A01D 43/08; C11B 1/04; C11B 1/06; C11B 1/10

(57) ABSTRACT

Systems are described that include a number of different components to allow for industrial scale crop processing to be performed, and for the products and by-products to be used, sold or traded, in areas that may not have the infrastructure to do so, wherein system comprising: an external housing container, comprising: a plant material processing module; a stalk processing module comprising stalk processing equipment; a seed processing module; one or more mechanical separators and/or conveyors within one or more of the modules and/or connecting two or more of the modules; at least one computer processor; and at least one electronic component.

### TECHNICAL FIELD

This disclosure generally relates to systems for growing and processing plants and plant materials.

### BACKGROUND

In developing countries, one hectare of land typically feeds about 4 people per year, but it is estimated that a hectare will need to feed 6 people or more per year to keep pace with population growth and diet changes. Improvements also need to be made in fighting pests, disease, flooding and droughts. According to the United Nations, about 40 percent of the world's crops are destroyed every year before they even leave the field as a result of pests, disease and weather. In many cases, while demand for food is increasing, the productivity of land is declining. For example, the soil is often so overused, the yields are sub-par to poor.

### SUMMARY

Systems are described that include a number of different components that allow for industrial scale crop processing to be performed, while simultaneously providing economic and/or environmental value in many of the products and by-products produced by such industrial scale crop processing, in areas that may not have the infrastructure to do so.

For example, a system is provided that includes one or more of the components described herein.

In one aspect, systems are provided that include an external housing container, wherein the external housing container can include a plant material processing module comprising one or more cutting mechanisms for chopping, cutting and/or shearing plant material; a stalk processing module comprising stalk processing equipment for producing fibrous material and/or compactor equipment for producing plant tissue bricks; a seed processing module comprising seed processing equipment for producing oil and/or biofuel; one or more mechanical separators and/or conveyors within one or more of the modules and/or connecting two or more of the modules; at least one computer processor; and at least one electronic component.

In some embodiments, a system as described herein further includes a furnace. In some embodiments, the plant tissue bricks are burned in a furnace contained within the system.

In some embodiments, a system as described herein further includes a power supply. Representative power supplies include, without limitation, generators and combustion engines. In some embodiments, the power supply is powered by biofuel produced in the stalk processing module.

In some embodiments, a system as described herein further includes one or more batteries for storing power produced by the system.

In some embodiments, a system as described herein further includes a heat exchanger for capturing and transferring heat produced by the system.

In some embodiments, a system as described herein further includes one or more holding tanks.

In some embodiments, a system as described herein further includes a drone and/or a drone module.

In some embodiments, a system as described herein further includes solar panels.

In some embodiments, a system as described herein further includes wind turbines.

In some embodiments, a system as described herein further includes a weather station.

In some embodiments, a system as described herein further includes a cold storage unit.

In some embodiments, a system as described herein further includes a water tank.

In some embodiments, a system as described herein further includes a biochar production module for producing biochar. Representative biochar production modules include a pyrolysis unit, and one or more collection tanks for collecting one or more by-products (syngas and pyroligneous acid (wood vinegar)). In some embodiments, the pyrolysis unit is fueled by one or more by-products (e.g., syngas).

In some embodiments, the system is mobile.

In some embodiments, the plant material processing module further comprises a separator for separating different types of plant tissue (e.g., stalks, seeds, flowers).

In some embodiments, the one or more cutting mechanisms comprises stripper blades and/or defoliating machinery.

In some embodiments, the plant material processing module further comprises a plant material dryer.

In some embodiments, the plant material processing module further comprises a dust collection system. In some embodiments, dust collected in the dust collection system is provided to the stalk processing module for use in the production of the plant tissue bricks.

In some embodiments, the stalk processing module further produces pulp.

In some embodiments, the seed processing module further produces seed meal cake.

In some embodiments, the seed processing equipment comprises one or more of a mechanical press, a centrifuge, a filtration system, a vacuum, a heater, a lyophilizer, a freeze-dryer, and a spray-dryer.

In some embodiments, the computer processor further comprises a server.

In some embodiments, the at least one electronic component imparts internet capabilities and/or cellular service capabilities.

In some embodiments, the at least one electronic component comprises one or more metering devices.

In some embodiments, the at least one electronic component comprises one or more monitoring devices.

In another aspect, methods of processing plant material in a system as described herein is provided. Such methods typically include introducing plant material into the plant material processing module, wherein seeds and/or flowers are separated from fibrous plant material, wherein the fibrous plant material is exposed to the one or more cutting mechanisms to chop, cut and/or shear the fibrous plant material; transferring the chopped, cut and/or sheared fibrous plant material into the stalk processing module, wherein the chopped, cut and/or sheared fibrous plant material is processed using the stalk processing equipment to produce biofuel and/or using the compactor equipment to produce plant tissue bricks; transferring the separated seed and/or flower to the seed processing module, wherein the seed and/or flower is processed using the seed processing equipment to produce oil; collecting the biofuel and/or oil in one or more storage tanks; and delivering the biofuel and/or oil to a power supply contained within the system.

In still another aspect, methods are provided that include separating seeds and/or flowers in plant material from fibrous plant material in the plant material; chopping, cutting and/or shearing the fibrous plant material to produce chopped, cut and/or sheared fibrous plant material; processing the chopped, cut and/or sheared fibrous plant material into biofuel and/or plant tissue bricks; processing the separated seeds and/or flowers into oil; and collecting and storing energy (e.g., electricity and/or heat) produced by the method.

Unless otherwise defined, all technical and scientific terms used herein have the same meaning as commonly understood by one of ordinary skill in the art to which the methods and compositions of matter belong. Although methods and materials similar or equivalent to those described herein can be used in the practice or testing of the methods and compositions of matter, suitable methods and materials are described below. In addition, the materials, methods, and examples are illustrative only and not intended to be limiting. All publications, patent applications, patents, and other references mentioned herein are incorporated by reference in their entirety.

### DESCRIPTION OF DRAWINGS

FIG. 1 is an exemplary SmartBox System (SBS) as described herein showing input and a number of potential outputs.

FIG. 2A is a detailed schematic showing various process streams and outputs generated by a SBS as described herein.

FIG. 2B is a detailed schematic for the oil and press meal module of a SBS as described herein.

FIG. 3 is an exemplary flowchart for processing of hemp plant to separate seeds and stalk for further production of oil, biochar, and/or bricks for processing of plant stalks.

FIG. 4A is an exemplary flowchart for processing hemp stalks.

FIG. 4B is an exemplary flowchart for production of hemp bricks from hemp stalks.

FIG. 5A is an exemplary flowchart for processing of plant seeds for production of hemp seed and cannabinoid infused oils, and press meal seed cake.

FIG. 5B is a schematic of a self-contained mobile processor for hemp seed oil production.

FIG. 6 is a schematic showing the process of production of biochar and wood vinegar from hemp stalks.

FIG. 7 is a schematic of the communications and data modules incorporated in a SBS as described herein.

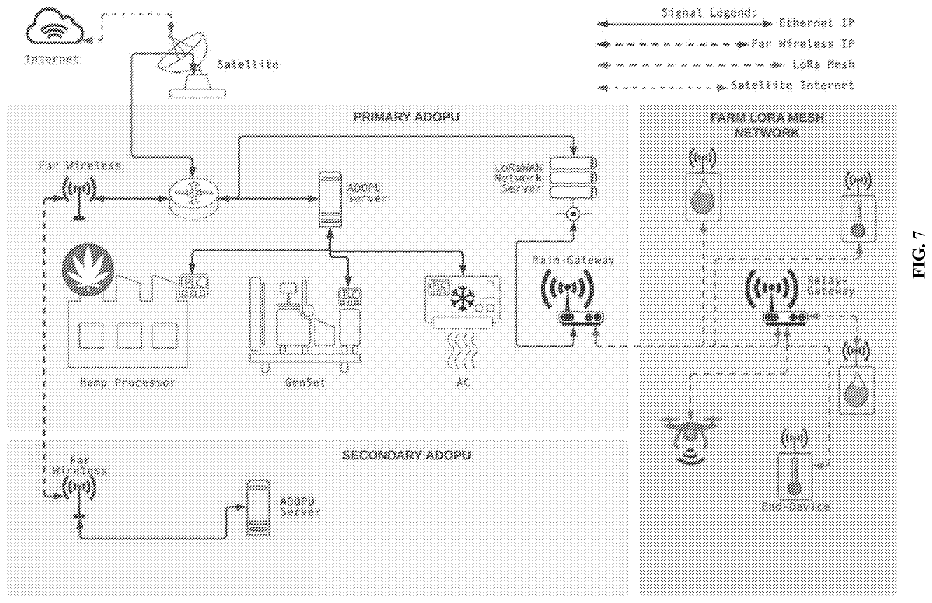

### DETAILED DESCRIPTION

SmartBox Systems (SBSs) as described herein are crop processing systems that include a number of different components to allow for industrial scale crop processing to be performed in areas that may not have the infrastructure to do so (e.g., remote geographical locations, locations in which centralized AC or DC electrical systems are unavailable). SBSs industrial plant processing systems provide global scale solutions to the ever-increasing levels of CO₂ and other greenhouse gas emissions caused by the burning of fossil fuels and the soil degradation caused by the present, industrialized methods in use by farmers today. In addition, SBSs as described herein can provide the means for a user or users (e.g., a small farmer or group of farmers) to grow and manage their crops with unprecedented efficiency, and can generate a number of different products or by-products that have economic and/or environmental benefits.

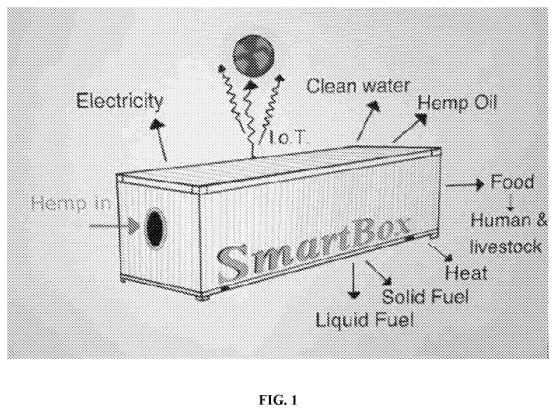

An exemplary SmartBox System (SBS) as described herein is shown in FIG. 1. As exemplified in FIG. 1, the processing of hemp within a SBS can result in the production electricity, clean water, hemp oil, food (e.g., human, livestock), heat, solid fuel, liquid fuel, data gathering (e.g., related to weather and crop) and/or communication capabilities (e.g., internet access, cellular communications). The external housing container of the SBS shown in FIG. 1 (e.g., the “box” in SmartBox) is, or is similar to, a rail car, however, the external housing container of an SBS can be any type of containment unit that houses one or more of the components or modules described herein.

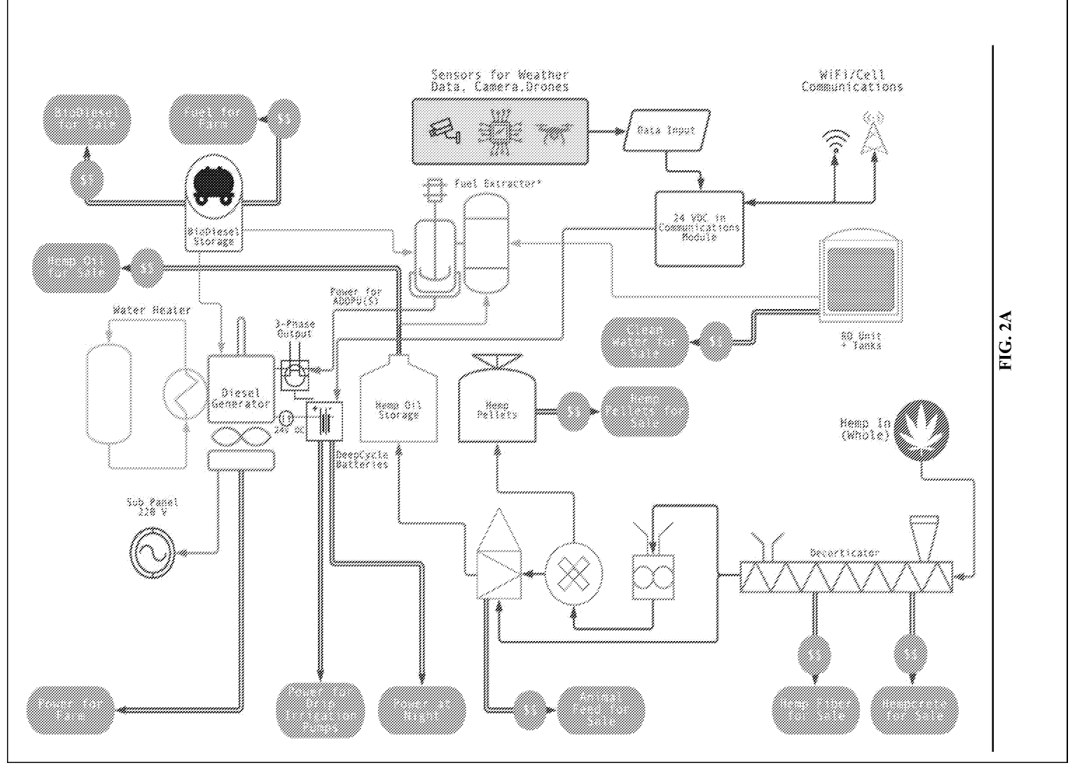

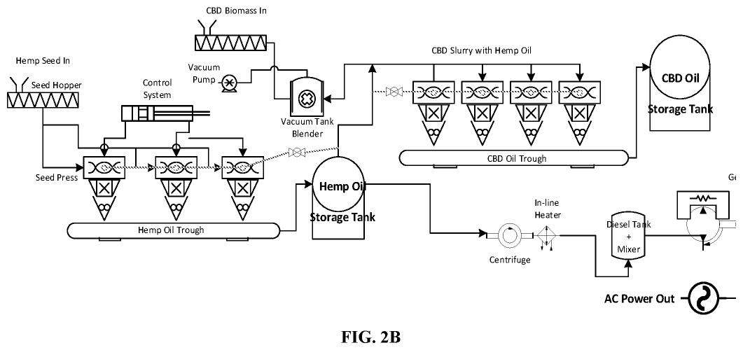

FIG. 2A shows a detailed schematic of a number of possible process streams that can take place in a SBS. As described herein, a SBS can generate a large number of outputs (e.g., the products or by-products resulting from the various reactions and processes occurring within a SBS) that can be monetized and/or commoditized using simple plant material as the input. While hemp is used herein to describe exemplary plant material that can be used in a SBS, the input plant material can be any number of plant species (e.g., non-hemp Cannabis, sweet corn, Moringa, pineapple). It would be appreciated that certain outputs will result from most plant species, while other outputs will be specific to certain plant species.

FIG. 2B is another embodiment of a SBS as described herein. It shows a system that is able to extract hemp seed oil from the hemp crop and purify and process it, e.g., to be able to run a generator to generate power. The ability of a SBS to have its own power source gives it the capacity to process plant materials as well as power other implements (e.g., farm implements) and systems such as water purification (e.g., reverse osmosis purification systems), farm irrigation pumps, crop and weather data collections systems and communication systems.

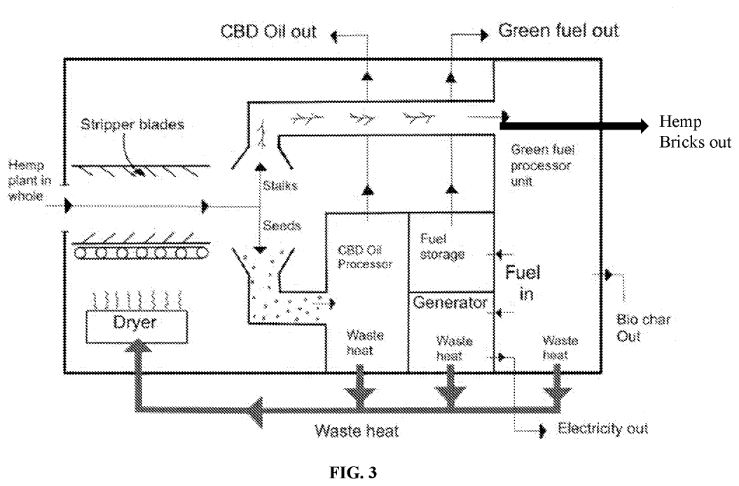

FIG. 3 shows a more detailed schematic of an exemplary SBS. As shown on the left side of FIG. 3, whole (or essentially whole) hemp plants can be introduced into the SBS (into, e.g., a plant material processing module). The hemp plants first can encounter one or more dryers to dry the plant material, if necessary, and one or more cutting mechanisms (e.g., stripper blades, defoliating machinery) to cut and shear the plant material in order to separate the seed and other plant biomass from the stalks. The stalk material can proceed into one or more stalk processing modules, where fibrous material (for use in, e.g., animal bedding, cloth and/or rope) and/or bricks of plant tissue can be produced, and the seeds and leaf material can proceed into one or more seed processing modules, where hemp oil (e.g., CBD oil) and/or biofuel (e.g., diesel fuel) can be produced. It would be appreciated that mechanical separators and conveyors can be used within or between one or more modules of a SBS to move material from one position to another.

As with FIG. 2A, FIG. 3 shows several different outputs that can be generated by a SBS, including, without limitation, the oils, CBD hemp oil and/or green biofuel (e.g., diesel) from the seed processing, and hemp bricks, which can be used as a fuel source, from the stalk processing. In addition, electricity can be produced by one of more of the processes described herein, and heat also can be produced, which, as shown in FIG. 3, can be recycled and re-used by the SBS (e.g., to facilitate the drying of plant material or in one or more of the processing steps) or used in any number of other ways by a user or users (e.g., individuals or a community) of the SBS (e.g., to heat homes, schools, businesses, etc.). As discussed in more detail below, many of the outputs of the SBS provide economic and/or environmental benefits, locally or globally. Production of hemp bricks results from compacting a large volume of stalks and biomass, which can be used either as a fuel by burning (e.g., in a furnace) or transported to other facilities where they can be processed further. Such facilities can include, for example, anaerobic digesters or biochar production units. The compaction of biomass also allows carbonaceous material to be sequestered simply by removing it from the carbon cycle (e.g., by burying it).

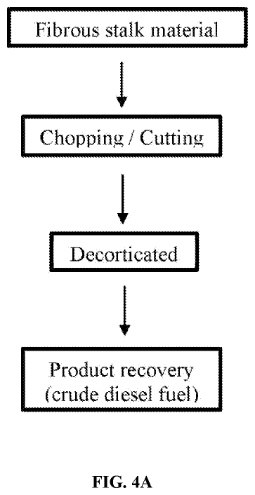

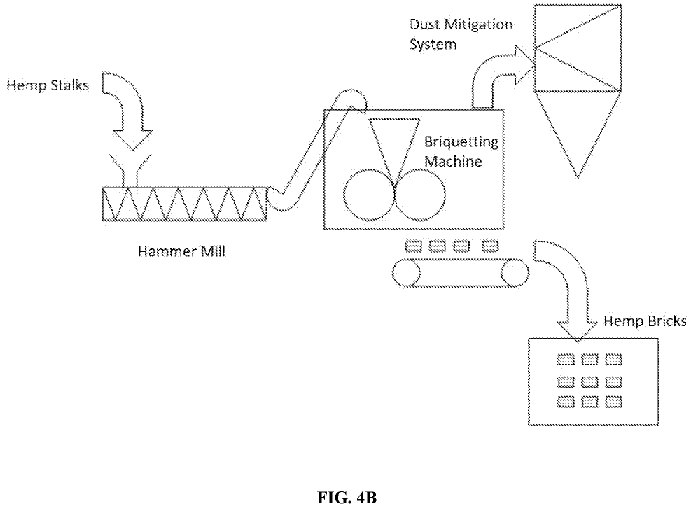

FIG. 4A is a flow chart that describes a representative pathway for processing the fibrous stalk material (e.g., stalk extraction). Generally, stalk material that has been reduced in size (e.g., by chopping or cutting) is decorticated by exposing the plant material to a compound that breaks down (e.g., deconstructs) the rigid cell walls, thereby exposing the cellulose, hemicellulose and lignin. The compound to which the plant material is exposed to break down the cell walls can be, without limitation, a chemical (e.g., a solvent), heat, pressure, biological enzymes, or combinations thereof. In addition, it would be understood that the plant material can encounter shearing, grinding, and/or cutting machinery more than once within a SBS (e.g., upon initial entry into a SBS as shown in FIG. 3 and/or after the plant seeds have been separated from the fibrous stalk material). The various components required to process and extract useful components from the fibrous stalk material can be referred to as stalk processing equipment.

FIG. 4B shows a detailed process diagram for processing hemp stalks into compacted hemp bricks or briquettes. One component of this system is the dust capture/mitigation system that traps the sticky hemp dust generated during the decorticating and hammer milling process. A SBS can reuse this hemp dust as a binder in the briquetting process. This produces hemp bricks that exhibit excellent thermal characteristics without the addition of any external binders. The resulting fibrous mass can be compressed into a solid brick shape, which increases the energy density for material to be used as a fuel. The various components required to produce bricks from the fibrous stalk material can be referred to as compactor equipment.

In one embodiment, plain hemp stalks can be used as a starting feed. The moisture content of the fibers can be monitored and kept in a range of about 8% to about 14%, with about 12% moisture content being optimal. As shown in FIG. 4B, the shredded hemp stalks of desired moisture content can be compressed using a briquetting device at pressures greater than 30,000 psi. The resulting brick can weigh about 1 kg and can be used as fuel source in stoves and other heating applications. A hemp brick made by the methods described herein was tested for its thermal properties and showed a heating value similar to firewood and sawdust fire logs. Table 1 shows the thermal properties when a hemp brick is used as a fuel. Proximate and ultimate analysis results showed a heat output of 7000 BTU/lb with an ash content of 3%. This compares favorably to current fire starter logs on the market (e.g., Duraflame®).

TABLE 1
Thermal analysis of bricks from waste hemp stalks (hemp heat)

| Parameter | As received | Dry | Method |
|---|---|---|---|
| Moisture | 8.56% | | |
| Ash, % | 3.07 | 3.36 | ASTM D482 |
| BTU/lb | 7076 | 7739 | ASTM D240 |
| Sulfur, % | 0.09 | 0.1 | ASTM D1552 |
| Carbon, % | 42.97 | 47 | ASTM D5291 |
| Hydrogen, % | 5.58 | 6.1 | ASTM D5291 |
| Nitrogen, % | 0.76 | 0.83 | ASTM D5291 |
| Oxygen, % | 39.05 | 42.71 | ASTM D5291 |

In another embodiment, hemp flowers and buds along with hemp stalks can be used as a starting feed to produce a unique aromatic heating source, referred to herein as a “cannabrick.” The resin from hemp flowers acts like a binder to create a solid brick. Table 2 shows the heating values for such a cannabrick, which can generate over 8000 BTU/lb with an ash content of 10%. The ratio of hemp flower biomass to hemp stalks can be altered to suit the product specifications. This aromatic product can be used, for example, as a flavoring additive in smoking meats, or as a hemp incense aromatherapy product.

TABLE 2
Thermal analysis of bricks from hemp flower (Cannabrick)

| Parameter | As received | Dry | Method |
|---|---|---|---|
| Moisture | 7.60% | | |
| Ash, % | 9.52 | 10.3 | ASTM D482 |
| BTU/lb | 8445 | 9140 | ASTM D240 |
| Sulfur, % | 0.39 | 0.42 | ASTM D1552 |
| Carbon, % | 47.49 | 51.4 | ASTM D5291 |
| Hydrogen, % | 6.29 | 6.81 | ASTM D5291 |
| Nitrogen, % | 3.3 | 3.57 | ASTM D5291 |
| Oxygen, % | 25.41 | 27.5 | ASTM D5291 |

The increased use of CBD-based products has resulted in a number of new processes for extracting cannabinoids from the flowers. These processes typically use organic solvents such as ethanol, hexane, butane, etc., to extract the cannabinoid oils into the organic phase. The remaining biomass then is discarded as waste. In one embodiment, the waste biomass from a solvent-based extraction process can be used as a starting feed. The resultant bricks show excellent physical properties. The ethanolic biomass can be burned easily with a low ash content. The briquetting mold shape can be changed to a small cylindrical puck shape for improved axial tensile strength properties. These bricks can be used, for example, as building materials (e.g., “hempcrete”), given the excellent load bearing capabilities.

The intermediates resulting from the plant material breaking down (e.g., crude bio-oils or other chemical building blocks) can be finished (e.g., purified, refined) or processed further (e.g., using a catalyst, by gasification, filtration) to improve one or more properties of the finished product (e.g., storage life, shelf stability). For example, bio-oil intermediates producing during stalk processing can be further refined into biofuel, and such biofuel can be used by the SBS (e.g., to power a generator and/or a combustion engine), stored in a tank (e.g., in a large capacity fuel storage tank) in (or near) the SBS for future use, and/or sold or traded to provide a source of income to the user or users.

The remaining fibrous portion (“pulp”) also can be used in any number of ways. For example, the pulp material can be dried and used as animal bedding (e.g., as a supplement to or in place of hay) or the pulp material can be dried and pelletized for use as a fuel (e.g., a combustible fuel). The pulp material additionally can be used in the production of hemp cloth or hemp rope. Any of these products that derive from the fibrous pulp portion of the stalk can be sold or traded to provide a source of income to the user or users.

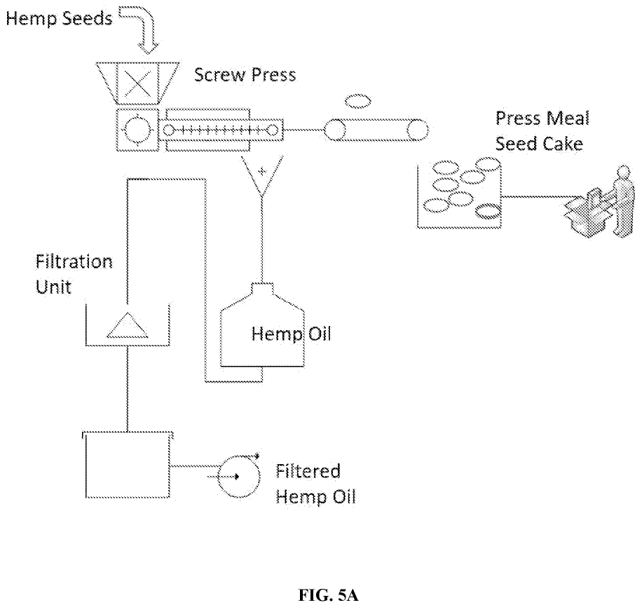

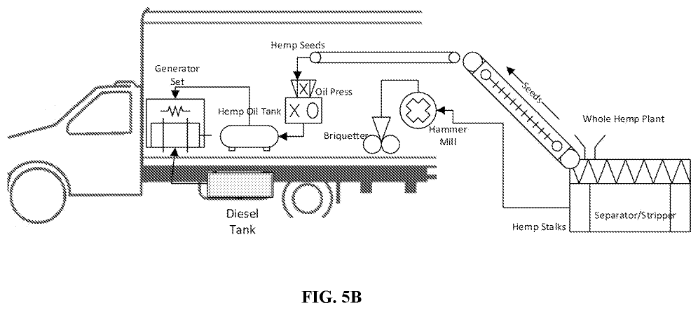

FIG. 5A is a flow chart that describes a representative method for processing plant seeds and other plant biomass. Processing seed typically begins by exposing the seed to a mechanical press (e.g., a screw press, a hydraulic press), which extracts the oil contained in the seeds. The extracted oil then can be further refined using, for example, an inline centrifuge and/or filtration system to obtain a pure or highly pure output. This process provides a stream of oil that can be used within the SBS (e.g., to power a diesel or turbine engine), stored in a holding tank in (or near) the SBS for future use, and/or sold or traded to provide a source of income to the user or users. The seed oil can be monetized directly, or the seed oil can be monetized by using it to obtain highly pure cannabinoids, including cannabidiolic acid (CBDA) or tetrahydrocannabinolic acid (THCA). In some instances, a SBS (e.g., a seed processing module) can include a vacuum, a lyophilizer, a freeze-dryer and/or a spray dryer so that one or more of the cannabinoids can be dried for easier handling and storing.

For example, methods of efficiently extracting cannabinoids from hemp plant material (e.g., biomass) using the naturally occurring oil instead of one or more solvents are described in U.S. application Ser. No. 17/345,923 filed on Jun. 11, 2021, which is incorporated by reference herein in its entirety. Briefly, a screw press can be used to compress the plant seeds and extract the oil. Concurrently, plant biomass containing cannabinoids also can be pressed, such that the seed oil acts as the carrier (solubilizing medium) for the desirable cannabinoids. Such methods can use one or more of the following components: a hammer mill (e.g., for reducing the size of the plant biomass); a feed hopper (e.g., for holding seed and biomass); a screw press (for compressing the seed to extract the oil); a heating mechanism; and various collection bins or tanks to hold or collect the products or by-products. These methods produce a cannabinoid-enriched oil in the absence of high temperatures, thereby allowing the naturally occurring cannabinoids to be obtained without altering their chemical structure (e.g., full spectrum cannabinoids). Simply by way of example, such cannabinoid-enriched oils can be used as a nutritional supplement or anti-inflammatory topical lotion.

The seed meal cake that remains following extraction of the oil can be, for example, high in protein and nutrients. Therefore, the seed meal cake that remains following extraction of the oil also can provide economic value to the user or users. For example, seed meal cake can be used as a food supplement for humans (e.g., the user or users), as an animal feed (e.g., for companion animals, livestock, or exotic/zoo animals), and/or sold or traded to provide a source of income to the user or users.

FIG. 5B shows an embodiment where a self-contained processing unit is mounted on a truck and brought to a field for onsite processing of the crops. Any number of configurations can be used to make a SBS mobile. For example, and without limitation, one or more of the modules described herein can be contained within a truck (as shown in FIG. 5B) or a trailer, which allows for different size SBS (e.g., 5 ft. length, 10 ft. length, 12 ft. length, etc.)

SBSs as described herein can include one or more power supplies. As used herein, a power supply can refer to a combustion engine and/or a generator. A power supply in a SBS can be, for example, a utility vehicle motor; a 10 kw DC generator; or an air cooled, 2 stroke, 20 hp diesel engine. The one or more power supplies in a SBS can not only power one or more components of the SBS, the one or more power supplies in a SBS also can provide power to a user or users of the SBS, or to a community (e.g., a village) located near the SBS. In addition, as described herein, the one or more power supply can run on oil produced within the SBS, and, therefore, operation of the SBS may require little to no fossil fuels. In some instances, a SBS can include one or more generators (e.g., large scale generators), which can provide industrial quantities of electrical power for other commodities (e.g., CBD oil, hempcrete) presently being made with fossil fuel power. Therefore, an SBS as described herein can further offset the amount of oil and gas that is pumped out of the ground and the amount of CO₂ that is released into the atmosphere.

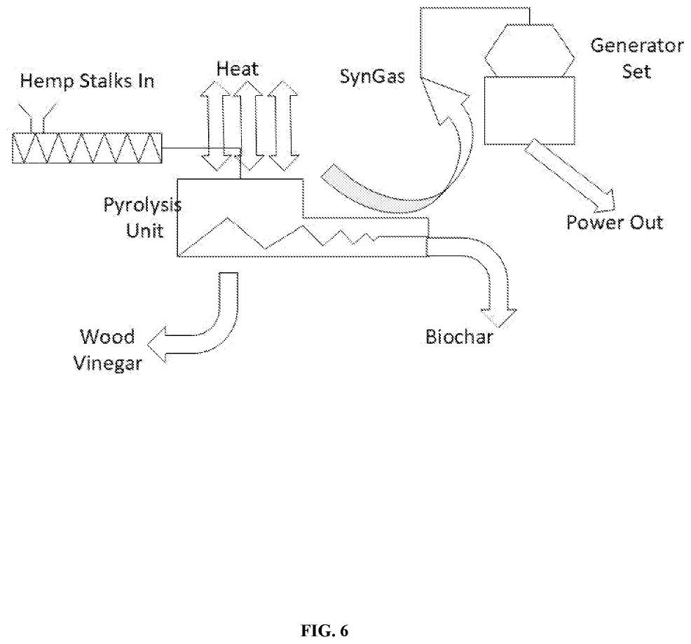

In another embodiment, an SBS as described herein can be used to produce biochar and the accompanying by-products, syngas and pyroligneous acid (e.g., wood vinegar). This can be accomplished, for example, by providing a biochar production module that includes, for example, a moving bed pyrolysis unit (FIG. 6). The starting material (e.g., feed stream) for the biochar can be any of the products or by-products from processing the plant material, including, without limitation, the bricks or briquettes (e.g., produced in a stalk processing module as described herein or, for example, in a separate stalk compression module). Pyrolysis is the heating of an organic material, such as biomass, in the absence of oxygen. Because no oxygen is present, the material does not combust, but the chemical compounds that make up the material thermally decompose into combustible gases and charcoal. Biochar has many benefits. On the environmental side, it offers an excellent way to dispose of organic materials without adding carbon to the atmosphere. In addition, biochar is an extremely beneficial soil additive that has many applications in agriculture. For example, biochar can improve plant growth by regulating nutrient release and heightening water retention due to its increased porosity. Biochar also reinforces the soil structure and boosts microbial activity in the soil.

Because biochar does not fully combust, it retains the carbon that would normally be released into the atmosphere with combustion. As such, it offers a legitimate way to capture carbon that is otherwise released with burning organic materials. Due to the unique way hemp biochar is created through pyrolysis, it can be burned without releasing carbon into the atmosphere. As such, hemp biochar is also a powerful carbon sequestration tool that can help reduce the greenhouse effect and global warming. For example, one hectare of industrial hemp can absorb 15 tonnes of CO₂ per hectare. The rapid growth of hemp makes it one of the fastest CO₂-to-biomass conversion tools available, even more efficient than agroforestry. For example, since the growing cycle for hemp is approximately 108 to 120 days, it is possible to grow two crops per year such that CO₂ absorption can be doubled.

The byproducts of this process are syngas and pyroligneous acid (e.g., wood vinegar). Wood vinegar is typically acidic in concentrated form with a pH between 2.5 to 3.0, and contains many important components that promote healthy growth in plants. Wood vinegar is a 100% natural garden and plant fertilizer. There are many uses for wood vinegar in agriculture. It is known to enrich the soil and improves germination of seedlings by enhancing the root system of the plants. Using wood vinegar has been known to increase the sugar content of fruits and results in better tasting fruit. Wood vinegar also boosts a plant's resistance to disease, speeds up the composting process and increases soil fertility.

Syngas is the other byproduct of the pyrolysis process. It is a combustible gas and can be used for the production of power in many types of equipment, from steam cycles to gas engines to turbines. The main application of syngas production usually is the generation of power and heat, which can be realized in stand-alone combined heat and power (CHP) plants or through co-firing of the product gas in large-scale power plants. In one embodiment, a portion of a syngas stream can be cooled from its exit temperature of 800° C. to about 350° C. and refluxed into the pyrolysis unit as a fuel. This can improve the thermal efficiency of the process while reducing the carbon emissions. The hot syngas also can be used to dry feedstock material prior to entry into a moving bed pyrolysis unit. Syngas can be used for electricity generation via, for example, an internal combustion engine or a gas turbine. Syngas also can be converted to hydrogen using steam methane reforming and can be used in fuel cells as a cleaner source of energy.

Biochar produced in a single run of the pyrolysis unit was tested for a number of physical chemical properties (Table 3).

TABLE 3
Chemical analysis of biochar

| | Dry | | |
|---|---|---|---|
| Parameter | basis | Units | Method |
| Moisture (time of | 7.5 | % wet wt. | ASTM D1762-84 |
| analysis) | | | (105c) |
| Bulk Density | 11.2 | lb/cu ft | |
| Organic Carbon | 78.1 | % of total | Dry Combust-ASTM |
| | | dry mass | D4373 |
| Hydrogen/Carbon (H:C) | 0.47 | Molar ratio | H dry combustion/C |
| | | | (above) |
| Total Ash | 5.3 | % of total | ASTM D1762-84 |
| | | dry mass | |
| Total Nitrogen | 0.51 | % of total | Dry Combustion |
| | | dry mass | |
| pH value | 9.01 | Units | 4.11USCC:dil. |
| | | | Rajkovich |
| Electrical Conductivity | 0.232 | dS/m | 4.10USCC:dil. |
| (EC20 w/w) | | | Rajkovich |
| Liming (neut. Value | 16.2 | % CaCO3 | AOAC 955.01 |
| as-CaCO3) | | | |
| Carbonates (as-CaCO3) | 1.8 | % CaCO3 | ASTM D4373 |
| Butane Act. | 5.4 | g/100 g dry | ASTM D5742-95 |
| Surface Area Correlation | 304 | M2/g dry | G |

| Chemical | | Range of | Reporting | |
|---|---|---|---|---|
| Compound | Results | Max Levels | Limit (ppm) | Method |
| Arsenic (As) | ND | 13 to 100 | 0.48 | J |
| Cadmium (Cd) | ND | 1.4 to 39 | 0.19 | J |
| Chromium (Cr) | 0.9 | 93 to 1200 | 0.48 | J |
| Cobalt (Co) | ND | 34 to 100 | 0.48 | J |
| Copper (Cu) | 7.4 | 143 to 6000 | 0.48 | J |
| Lead (Pb) | 0.3 | 121 to 300 | 0.19 | J |
| Molybdenum (Mo) | ND | 5 to 75 | 0.48 | J |
| Mercury (Hg) | ND | 1 to 17 | 0.002 | EPA 7471 |
| Nickel (Ni) | 1.0 | 47 to 420 | 0.48 | J |
| Selenium (Se) | ND | 2 to 200 | 0.95 | J |
| Zinc (Zn) | 7.0 | 416 to 7400 | 0.95 | J |
| Boron (B) | 8.4 | Declaration | 4.76 | TMECC |
| Chlorine (Cl) | ND | Declaration | 20.0 | TMECC |
| Sodium (Na) | ND | Declaration | 475.7 | E |
| Iron (Fe) | 215 | Declaration | 23.8 | E |
| Manganese (Mn) | 22 | Declaration | 0.48 | J |

All units mg/kg dry unless stated otherwise
ND = not detected, which means the result is below the reporting limit

| | | |
|---|---|---|
| Particle size distribution | Results (%) | Method |

| | | | |
|---|---|---|---|
| <0.5 | mm | 5.0 | F |
| 0.5-1 | mm | 3.5 | F |
| 1-2 | mm | 7.9 | F |
| 2-4 | mm | 23.6 | F |
| 4-8 | mm | 34.6 | F |
| 8-16 | mm | 25.4 | F |
| 16-25 | mm | 0.0 | F |
| 25-50 | mm | 0.0 | F |
| >50 | mm | 0.0 | F |

| Soil Enhancement Properties | Results | | Method |
|---|---|---|---|
| Total (K) | 3339 | mg/kg | E |
| Total (P) | 239 | mg/kg | E |
| Ammonia (NH4—N) | 1.3 | mg/kg | A |
| Nitrate (NO3—N) | 0.5 | mg/kg | A |
| Organic (Org-N) | 5077 | mg/kg | Calc. |

| | | |
|---|---|---|
| Volatile Matter | 22.6% dry weight | D |

Methods for Table 3: A, Rayment & Higginson; D, ASTM D1762-84; E, EPA3050B/EPA 6010; F, ASTM D2862 Granular; G, Butane Activity Surface Area Correlation Based on Mclaughlin, Shields, Janiello, & Thiele's 2012 paper: Analytical Options for Biochar Adsorption and Surface Area; J, EPA3050B/EPA 6020

A SBS as described herein can include one or more computer processor components and/or one or more electronic components for performing any number of tasks.

For example, a SBS as described herein can include a self-powered, portable, virtual server that utilizes known technology to create a digital cloud that is managed by the SBS. The presence of such a server in a SBS can significantly increase the overall efficiency of the SBS by eliminating, or at least markedly reducing, the need for large quantities of hardware and electrical power required in conventional data centers. The presence of such a server in a SBS also can allow for the ability to provide education materials (e.g., to children and schools) in rural or remote locations. In addition, the presence of such a server in a SBS can be used for data mining (e.g., BitCoin) or hardware intensive operations such as a render farm.

A SBS as described herein also can include any number of means for communicating (e.g., between users, between SBSs, etc.). For example, a SBS can provide Wi-Fi (e.g., using terrestrial- or satellite-based internet services (e.g., STARLINK)) and/or cellular service that can be used, without limitation, for transmitting and receiving information regarding, e.g., plants, fields and/or weather, and to provide internet access to allow for cellular and/or internet connections (for, e.g., mobile banking). These features are particularly important in developing countries or remote regions in developed countries. A SBS also can include one or more drones and the accompanying equipment, e.g., in a drone module. A drone can be used to obtain photos or other field data (to determine, e.g., the amount of carbon being sequestered in soil, in plants, etc.) or deliver materials to fields, users or communities near the SBS.

For example, a SBS as described herein can include electronic components for metering electricity (e.g., revenue grade electricity metering); metering carbon usage or offset (e.g., sequestration); monitoring surplus electrical power produced and/or stored by the SBS; monitoring load conditions on the SBS; reporting on the status of various functions or activity in the SBS; acting as a node in a meshed network; linking other functions or activities within a SBS; communicating with other SBSs in different locations; and/or connecting a SBS to an internet gateway, satellite uplinks or other forms of global communications.

A SBS as described herein also can include one or more SBS specific software programs to, for example, interface with local users. Such an interface can include, without limitation, a cellular device, an unmanned aerial vehicle (e.g., a drone), or other suitable hardware that can capture images of the land and the crops being grown; connect one or more users to a SBS database; provide recommendations or instructions on growing particular crops (e.g., planting conditions, when to fertilize and with what; irrigation requirements); provide information on the growth of particular crops (e.g., yield, cost); and provide a means for users or groups of users to combine resources, which, for example, can allow users access to markets far larger than they're able to access individually.

In some instances, the various communication means can be powered by a generator (e.g., an electric generator) that can be fueled using, for example, biofuel produced within the SBS or using power supplied from other available sources (e.g., solar panels, wind turbines). It would be appreciated that a SBS as described herein can include internal and external analog and digital inputs and outputs as needed for the required applications.

A SBS as described herein further can include any number of additional components. The following descriptors are intended to be exemplary, and not exhaustive. For example, a SBS as described herein can include: one or more dryers; one or more heaters; one or more heat exchangers; one or more water pumps; one or more filters or filtration devices (e.g., for extracting toxins from plant material or for use in one or more of the processing methods); a timer; a reverse osmosis unit (e.g., for producing clean water, which can be used internally by a SBS, by one or more users or sold or traded to provide a source of income to the user or users); a weather station of one or more components thereof (e.g., barometer, thermometer, hygrometer, anemometer, pyranometer); a source of, or means to produce, hydrogen (to improve/increase fuel economy, power output, emissions, etc. in an internal combustion engine); one or more storage bins or tanks (e.g., for storing plant material (intake or waste); oil; fuel; water); and/or one or more specialty components (e.g., necessary for a particular type of growth conditions or processing parameters).

A SBS as described herein also can include solar panels and/or wind turbines mounted on or near the SBS (e.g., approximately 33 5½′×3½′ panels would cover an 8′×40′ box). Solar and/or wind power generated can be stored in, for example, a battery reservoir in the SBS (e.g., multiple 12V deep cycle batteries) or sold or traded to provide a source of income to the user or users. In some instances, it may be desirable to use acoustic insulation on or in a SBS for the purpose of noise abatement.

A SBS as described herein further can include means for cold storage (e.g., an insulated container). Such cold storage can be equipped with an integrated cooling system powered, for example, by a SBS generator. Cold storage provided by a SBS can be used for food stuffs or other perishable items such as vaccines or other medicines.

One or more of the components described herein can be assembled into one or more modules, which can be used in various combinations to generate SBSs as described herein. A SBS as described herein can contain one or more “standard” modules (e.g., one or more power modules) and/or one or more “custom” modules (e.g., specific for a particular plant being grown and/or processed (e.g., CBD extraction equipment) and/or the particular user or users of a SBS (e.g., a communication module)). Modules can be used to simplify construction and/or repair of components, to make customization easier, and/or to reduce manufacturing costs.

In some instances, it may be desirable for the SBS to be mobile. FIG. 5 shows an embodiment in which the SBS is on a container truck. For example, a truck can be configured to have more than one throttle control—one to control the truck engine and another to control, for example, a generator. In some instances, a tractor (e.g., a combine) can provide mobility to a SBS as well as a power supply. For example, a tractor can power a SBS via a hydraulic feed or a power take-off (PTO) and, in return, fuel produced in the SBS can power the tractor.

Representative specifications from an exemplary SBS are shown in Table 4. Using hemp as an example, and assuming the following: that one SBS can serve 300 hectares, that hemp plants can produce about 3,000-5,000 seeds per acre per crop, that up to three crops can be grown each year in some geographical areas, and that at least four tons of plant material can be processed per hour, then up to 2,500 L of oil per hour can be produced. These numbers can be increased even further by planting, for example, feminized hemp seed or super-seed producer varieties.

TABLE 4
Representative Specifications of an Exemplary SBS

| | | |
|---|---|---|
| Processor Capacity | 500 | lb/hr |
| Duty cycle % | 75 | % |
| # of processors/SB | 2 | |
| Oil content | 30 | % |
| Seeds processed per year | 6,570,000 | lbs |
| Oil produced per year | 1,971,000 | lbs |
| Oil volume per year | 973,814 | liters |
| Seed produced/acre | 2,000 | lbs |
| Area cultivated | 3,285 | acres |
| Tons of CO2 removed | 32,850 | tons/year |

### Benefits of a SmartBox System

The benefits of a SBS as described herein are numerous. Simply by way of example, a SBS as described herein can:
Meter and measure carbon sequestration, which can be converted into carbon credits (e.g., carbon emission reduction credit (CERC) or emission reduction unit (ERU)), which can be traded, for example, on the Chicago Climate Exchange (CCX);
Evaluate, qualitatively or quantitatively, passively or actively, nutrient levels, moisture levels, carbon levels, etc. using, for example, drones and/or meters;
Provide industrial quantities of electrical power for communities or manufacturing plants, further offsetting fossil fuel usage;
Produce clean water;
Produce heat;
Produce high quality food (e.g., human and animal) from waste stream; and/or
Provide information and planting recommendations so as to maximize soil remediation (e.g., via intercropping).
Provide local telecommunication and internet infrastructure

A SBS as described herein can meet good manufacturing practice (GMP) standards to ensure that outputs are consistently produced and meet particular quality standards and to minimize the risks involved in variability in food and pharmaceutical products. See, for example, 21 CFR §§ 4, 110, 111, 210, 211, and/or 820. For example, the byproduct of seed pressing (e.g., seedcake or presscake) can be used as GMP-quality food, feed or nutritional supplement.

It is to be understood that, while the methods and compositions of matter have been described herein in conjunction with a number of different aspects, the foregoing description of the various aspects is intended to illustrate and not limit the scope of the methods and compositions of matter. Other aspects, advantages, and modifications are within the scope of the following claims.

Disclosed are methods and compositions that can be used for, can be used in conjunction with, can be used in preparation for, or are products of the disclosed methods and compositions. These and other materials are disclosed herein, and it is understood that combinations, subsets, interactions, groups, etc. of these methods and compositions are disclosed. That is, while specific reference to each various individual and collective combinations and permutations of these compositions and methods may not be explicitly disclosed, each is specifically contemplated and described herein. For example, if a particular composition of matter or a particular method is disclosed and discussed and a number of compositions or methods are discussed, each and every combination and permutation of the compositions and the methods are specifically contemplated unless specifically indicated to the contrary. Likewise, any subset or combination of these is also specifically contemplated and disclosed.

1. A system comprising:
an external housing container, comprising:
a plant material processing module comprising one or more cutting mechanisms for chopping, cutting and/or shearing plant material;
a stalk processing module comprising stalk processing equipment for producing fibrous material and/or compactor equipment for producing plant tissue bricks;
a seed processing module comprising seed processing equipment for producing oil and/or biofuel;
one or more mechanical separators and/or conveyors within one or more of the modules and/or connecting two or more of the modules;
at least one computer processor; and
at least one electronic component.

2. The system of claim 1, further comprising a furnace.

3. (canceled)

4. The system of claim 1, further comprising a power supply.

5-6. (canceled)

7. The system of claim 1, further comprising one or more batteries for storing power produced by the system.

8. The system of claim 1, further comprising a heat exchanger for capturing and transferring heat produced by the system.

9. The system of claim 1, further comprising one or more holding tanks.

10. The system of claim 1, further comprising a drone and/or a drone module.

11. The system of claim 1, further comprising solar panels.

12. The system of claim 1, further comprising wind turbines.

13. The system of claim 1, further comprising a weather station.

14. The system of claim 1, further comprising a cold storage unit.

15. The system of claim 1, further comprising a water tank.

16. The system of claim 1, further comprising a biochar production module for producing biochar.

17-20. (canceled)

21. The system of claim 1, wherein the one or more cutting mechanisms comprises stripper blades and/or defoliating machinery.

22. The system of claim 1, wherein the plant material processing module further comprises a plant material dryer.

23-27. (canceled)

28. The system of claim 1, wherein the computer processor further comprises a server.

29. The system of claim 1, wherein the at least one electronic component imparts internet capabilities and/or cellular service capabilities.

30. The system of claim 1, wherein the at least one electronic component comprises one or more metering devices.

31. The system of claim 1, wherein the at least one electronic component comprises one or more monitoring devices.

32. A method of processing plant material in the system of claim 1, comprising:
introducing plant material into the plant material processing module, wherein seeds and/or flowers are separated from fibrous plant material, wherein the fibrous plant material is exposed to the one or more cutting mechanisms to chop, cut and/or shear the fibrous plant material;
transferring the chopped, cut and/or sheared fibrous plant material into the stalk processing module, wherein the chopped, cut and/or sheared fibrous plant material is processed using the stalk processing equipment to produce biofuel and/or using the compactor equipment to produce plant tissue bricks;
transferring the separated seed and/or flower to the seed processing module, wherein the seed and/or flower is processed using the seed processing equipment to produce oil;
collecting the biofuel and/or oil in one or more storage tanks; and
delivering the biofuel and/or oil to a power supply contained within the system.

33. A method comprising:
separating seeds and/or flowers in plant material from fibrous plant material in the plant material;
chopping, cutting and/or shearing the fibrous plant material to produce chopped, cut and/or sheared fibrous plant material;
processing the chopped, cut and/or sheared fibrous plant material into biofuel and/or plant tissue bricks;
processing the separated seeds and/or flowers into oil; and
collecting and storing energy produced by the method.
